(19) United States
(12) Patent Application Publication
(10) Pub. No.: US 2015/0198322 A1
(43) Pub. Date: Jul. 16, 2015

(54) LIQUID COOLED LIGHT EMITTING DIODE DEVICES

(71) Applicant: National Taiwan University of Science and Technology, Taipei City (TW)

(72) Inventor: Jung-Chieh Su, Taiwan (TW)

(21) Appl. No.: 14/312,053

(22) Filed: Jun. 23, 2014

(30) Foreign Application Priority Data
Jan. 13, 2014 (TW) 103101122

(51) Int. Cl. F21V 29/58; F21V 29/71; F21K 99/00

(52) U.S. Cl. CPC F21V 29/59; F21K 9/56; F21V 29/717; F21Y 2113/005

(57) ABSTRACT

The present invention discloses a liquid cooled LED device, comprising a cooling module, a LED array module and a hollow outer tube. The cooling module comprises an inner tube for liquid conveyance having an outer surface and a pipe. The inner tube provides a cooling liquid to flow through. The LED array module is set on the outer surface of the inner tube for liquid conveyance, which is inserted into the hollow outer tube, and two of which are sealed by the hollow outer tube to prevent the cooling liquid from permeating into the LED array module set on the outer surface. The LED array module comprises a plurality of light emitting components which are set on the outer surface of the inner tube for liquid conveyance in an omnidirectional or a semi-omnidirectional configuration.

### PRIORITY CLAIM

This application claims the benefit of the filing date of Taiwan Patent Application No. 103101122, filed Jan. 13, 2014, entitled “LIQUID COOLED LIGHT EMITTING DIODE DEVICES,” and the contents of which is hereby incorporated by reference in its entirety.

### FIELD OF THE INVENTION

The present invention relates to a liquid cooled light emitting diode (LED) device, more particularly, to an omnidirectional or a semi-omnidirectional liquid cooled LED device.

### BACKGROUND OF THE INVENTION

LED lamp is an environmental protecting and energy-saving lighting product, when compared to traditional lighting lamps; it has many advantages, such as low energy consumption, long lifespan, durability, etc. LED lamps convert 15% to 20% of the input electrical energy into visible light while the remaining part of the energy is converted into dissipated heat. Because the heat generating rate usually is higher than the dissipation rate, the LED junction temperature rises rapidly above the environmental temperature. At the same time, the heat loss is enhanced by changing optical properties of chip epitaxial materials and so as to accumulate to high temperature. The rising junction temperature of the LED chips decreases the luminous efficiency and lifetime of LEDs in the time course of operation. Therefore, the heat loss per unit volume is high enough as comparing with the other lighting devices. If the wasted thermal energy from the heat of the electric energy loss is not effectively dissipated, it will lead to the lower luminous efficiency and the shortened lifetime of the LED lamps greatly. Therefore, efficiently dissipating heat of LED lighting products is one of the important factors in the enhancement of lighting efficiency. Currently, most methods of heat dissipation involve using a heat sink, adding fans to force the heat to dissipate, and using a remote heat exchanger (heat pipe type) etc.

Furthermore, because of the contemporary tendency of “going green”, food safety, food mileage pollution-free, energy-saving are highly valued, the trend towards good agricultural practice is continuing, which also leads to a good perspective of the LED plant lamps for plant factory industry or greenhouse. Basically, indoor organic farming is developed to reduce the likelihood of microbial or other contamination of fresh crops, fruits and vegetables in pollution-free, controlled lighting, humidity and temperature environments according to the requirement of plant growth and growth stages in the life cycle of crops, fruits and vegetables. Therefore the market needs highly efficient LED plant lamps for controlled lighting in plant factory or greenhouse.

In terms of the applications for LED plant lamps, there is a need for adjusting different light source spectrums during different growth stages of plants and continuously providing so called “light fertilizer” to the plants in the time course of growth. Therefore effectively dissipating heat of LED plant lamps is critical. The conventional method of dissipating heat of LED lamps mainly adopts air cooling, however, a large amount of energy is consumed by the air conditioning to control the temperature of the greenhouse or plant factory and maintain the stability of the plant growth. Such conventional LED lamps use passive thermal radiation and conduction heat sink, namely by connecting aluminum, ceramic, plastic, or other material substrates as submounts, on which LED chips or device are positioned. These materials conduct the heat generated from the LED chips and radiate outward. The drawback of this approach is the requirement of maximizing the surface area of the materials in contact with the surrounding cooling medium and good thermal conducting material properties, which limit the efficiency of thermal dissipation. Other auxiliary thermal dissipation techniques use fan or liquid cooling to accelerate the dissipation efficiency of the above heat sink, since cooling flow velocity, choice of material, surface area are factors that affect the performance of the heat sink. Moreover, heat sink attachment and thermal interface materials also affect the chip temperature of the LED devices. Thermal adhesive improves the heat sink's performance by filling air gaps between the heat sink and the LED devices. The conventional air-cooled LED light source usually adds fan to enhance the heat dissipation efficiency. Due to have large surface area, the heat sink needs a large power consumption to drive the fan for forced cooling. The conventional liquid-cooled LED light sources usually are attached on an aluminum substrate as a cooling backboard to rapidly transfer the generated heat from the LED light source. The dissipated heat on the surface of the aluminum substrate is then taken away by a distributed pipeline and working fluid (e.g., water), which is forcibly convected through a pump. However, because of the conventional liquid-cooled LED light sources having a planar configuration, its light intensity pattern cannot be applied to the requirement of omnidirectional or semi-omnidirectional illumination patterns and the application of water immersion LED light sources, such as an ultraviolet immersion lamp for sewage treatment, algae growth lamp for biofuels, fishing lamp, and other immersion lighting sources.

According to the above description, one can understand that due to the conventional liquid-cooled LED light sources having a planar configuration, it cannot be applied to the requirements of omnidirectional or semi-omnidirectional illumination patterns or the application of water immersion LED light sources. Therefore, it is necessary to improve the method of cooling efficiency in order to solve the drawback of the conventional liquid-cooled LED device.

### SUMMARY OF THE INVENTION

In order to achieve the above purposes, the present invention provides a liquid cooled LED device, comprising a cooling module, a LED array module, and a hollow outer tube. The cooling module comprises an inner tube for liquid conveyance. The inner tube with an outer surface and a pipe is inserted into the hollow outer tube and used to provide a cooling liquid to flow through. The LED array module is set on the outer surface of the inner tube for providing light emission. The inner surface of the hollow outer tube covers the outer surface of the inner tube for preventing liquid permeation, and the two ends of the hollow outer tube is sealed to prohibit the cooling liquid from permeating into the LED array module set on the outer surface of the inner tube.

In addition, the LED array module comprises a plurality of light emitting components and a driving circuit. Each LED component of the LED array module comprises at least one LED chip and a lead frame. The at least one LED chip is attached on the lead frame, while the lead frame is attached on the outer surface of the inner tube by thermal adhesive and is connected to the driving circuit, wherein the plurality of light emitting components may be set on the outer surface of the inner tube in an omnidirectional or a semi-omnidirectional configuration.

Furthermore, the cooling module further comprises a piping system, a pump and a heat sink. The piping is connected to the two ends of the inner tube for liquid conveyance. The pump is connected to the piping system to pump the cooling liquid through the inner tube for transferring liquid. The heat sink is connected to the piping to cool the cooling liquid.

Compared to the prior art, the present invention provides a liquid cooled LED device that achieves the omnidirectional or semi-omnidirectional illumination pattern by using a cylindrical configuration of LED array module, which is set on the cylindrical outer surface of the inner tube.

Meanwhile, the inner surface of the hollow outer tube covers the outer surface of the inner tube, preventing liquid permeation, and the sealed two ends of the hollow outer tube, which can be applied in liquid immersion LED light sources.

### BRIEF DESCRIPTION OF THE DRAWINGS

FIG. 1 is a schematic diagram of the liquid cooled LED device according to the first embodiment of the invention.

FIG. 2 is a schematic diagram of the light emitting component of the invention.

FIG. 3 is a schematic diagram of the liquid cooled LED device according to the second embodiment of the invention.

FIG. 4 is a schematic diagram of the liquid cooled LED device according to the third embodiment of the invention.

FIG. 5 is a schematic diagram of the liquid cooled LED device according to the fourth embodiment of the invention.

FIG. 6 is a schematic diagram of the liquid cooled LED device according to the fifth embodiment of the invention.

FIG. 7 is a schematic diagram of the liquid cooled LED device according to the sixth embodiment of the invention.

FIG. 8 is a schematic diagram of the driving circuit of the invention.

### DETAILED DESCRIPTION

In order for the purpose, characteristics and advantages of the present invention to be more clearly and easily understood, the embodiments and appended drawings thereof are discussed in the following.

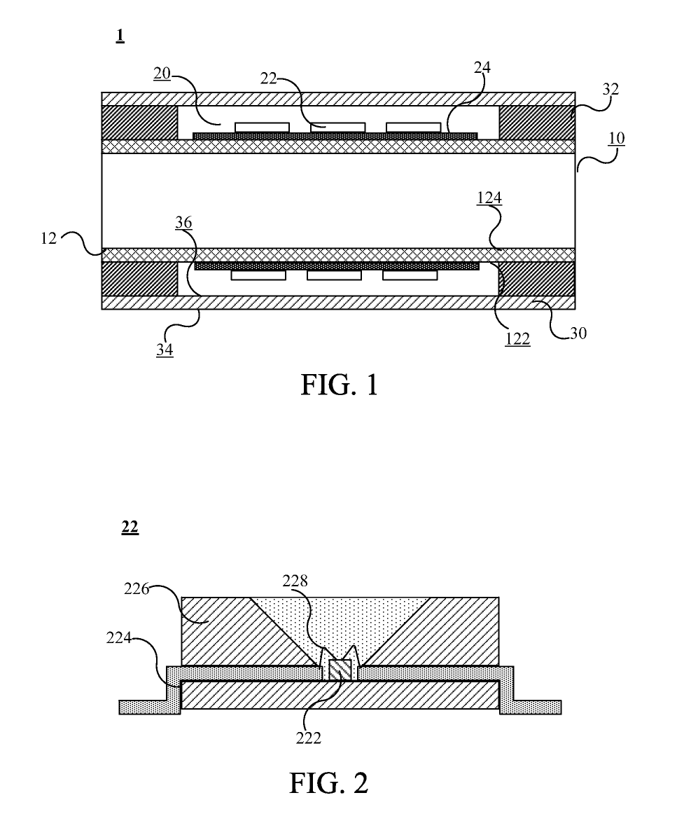

Please refer to FIG. 1, FIG. 2, and FIG. 8. FIG. 1 illustrates a schematic diagram of the liquid cooled LED device according to the first embodiment of the invention. FIG. 2 illustrates a schematic diagram of the light emitting component of the invention. FIG. 8 illustrates a schematic diagram of the driving circuit of the invention. The present invention provides a liquid cooled LED device 1, which comprises a cooling module 10, a LED array module 20, and a hollow outer tube 30. The cooling module 10 comprises an inner tube 12 for liquid conveyance which has an outer surface 122 and a pipe 124. The pipe 124 provides a cooling liquid (not shown in the FIG. 1) to flow through, but is not limited to the type of cooling liquid. In practical applications, the cooling liquid may also be cooling water for generating the cooling effect by flowing through the inner tube for water conveyance. The cooling liquid is represented by water in the following embodiments. In the present embodiment, the inner tube 12 for water conveyance is a plastic pipe, but is not limited to its material. In practical applications, the inner tube 12 for water conveyance may also be a metal pipe or any other material with thermal conduction characteristics. The LED array module 20 is set on the outer surface 122 of the inner tube 12 for water conveyance. The omnidirectional (0-360 degree) or semi-omnidirectional (0-180 degree) illumination pattern is provided by the LED array module 20 that is set on the cylindrical outer surface 122 of the inner tube 12 for water conveyance. In the present embodiment, the cross-sectional area of the inner tube 12 for water conveyance is circular, but is not limited to a circular shape. In practical applications, the cross-sectional area of the inner tube 12 for water conveyance may also be an oval or any other shape that can achieve the omnidirectional or semi-omnidirectional illumination pattern. The LED array module 20 comprises a plurality of light emitting components 22 and a driving circuit 24. Each light emitting component 22 comprises at least one LED chip 222, a lead frame 224, and a substrate 226 having a reflective surface. The lead frame 224 is attached on the inner surface of the substrate 226, while a chip adhesion clearance is provided for generating the chip adhesion layer. The at least one LED chip 222 is attached on the lead frame 224. Then, the lead frame 224, which consists of electrode connecting wires 228, is attached on the outer surface 122 of the inner tube 12 for water conveyance by thermal adhesive (not shown in the FIG. 1) and connected to the driving circuit 24. In the present embodiment, the driving circuit 24 is composed of copper foil wire, but is not limited to a specific type of wire. In practical applications, the driving circuit 24 may also be silver paste, silver aluminum paste, silver tape, copper tape, or any other material that can be used as the material of the driving circuit 24. The light emitting component 22 is then connected to the driving circuit 24 in parallel, but is not limited to a specific orientation. In practical applications, the light emitting component 22 may also be connected to the driving circuit 24 in a series. Finally, the anode end 24a and cathode end 24b of the driving circuit 24 are passed through the two ends of the hollow outer tube 30 and support the current using the external power source 26. The hollow outer tube 30 is used to cover the outer surface 122 of the inner tube 12. The two ends of the hollow outer tube 30 are sealed by the sealing piece 32 to prevent the water from permeating into the outer surface 122 on which the LED array module 20 is set, and achieves a waterproofing effect. The liquid cooled LED device 1 of the invention can be immersed directly into the water, achieving the heat-dissipation effect with flowing water through the inner tube 12. In practical applications, the invention may also be applied to waterproof lamps or water immersion lamps for algae growth and water treatment, and is not limited to the above applications.

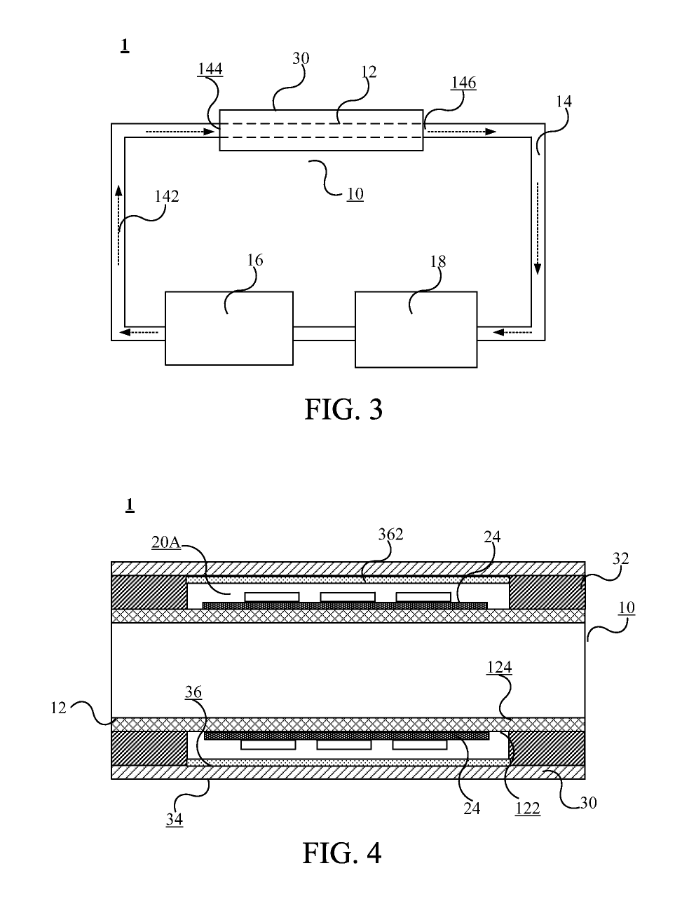

Now please refer to FIG. 1 and FIG. 3. FIG. 3 illustrates a schematic diagram of the liquid cooled LED device according to the second embodiment of the invention. The cooling module 10 further comprises a piping 14, a pump 16, and a heat sink 18. In the present embodiment, the piping 14 may be a rubber pipe, but is not limited to a specific material. In practical applications, the piping 14 may also be a soft plastic pipe or any other type of soft pipe. The piping 14 is connected to the two ends of the pipe 124 of the inner tube 12 to respectively form an inlet end 144 and an outlet end 146. The pump 16 is connected to the inlet end 144 of the piping 14 for pumping the cooling liquid 142 to make it flow through the pipe 124 of the inner tube 12, which makes the LED array module 20 achieve effective heat dissipation. The heat sink 18 is connected to the outlet end 146 of the piping 14 to cool the cooling liquid 142 after absorbing the generated heat from the LED array module 20. In practical applications, in terms of a large number of plant lamps for growth continuously provide lighting for a long period of time, the invention can stabilize the temperature of the greenhouse with minimum energy consumption.

Please refer to FIG. 4, which illustrates a schematic diagram of the liquid cooled LED device according to the third embodiment of the invention. The present invention provides a liquid cooled LED device 1, which comprises a hollow outer tube 30 having an outer surface 34 and an inner surface 36. In the present embodiment, the hollow outer tube 30 is a hollow acrylic tube, but is not limited to a specific material. In practical applications, the hollow outer tube 30 may also be made of glass, crystal, or any other material that has an optical transparency effect. The inner surface 36 of the hollow outer tube 30 is coated with phosphor resin layers 362 of a mixing of single or multiple color phosphors and transparent optical resin. The LED array module 20 is a LED module comprises three LED pumping chips 20A of blue, purple and ultraviolet wavelengths, which is set on the outer surface 122 of the inner tube 12. The ultraviolet LED chip is driven to emit ultraviolet light, the purple LED chip is driven to emit purple light, and the blue LED chip is driven to emit blue light (not shown in the FIG. 4) by inputting driving current from the external power source to the LED module with three wavelength pumping chips 20A. When the blue light, ultraviolet light, or purple light, or any combination of multiple optical wavelengths thereof excite the phosphor resin layers 362 of a mixing of single or multiple color phosphors and transparent optical resin, the single or multiple optical wavelength combinations excite the phosphor resin layers 362 to emit visible light with specific or multiple colors (not shown in the FIG. 4). The emitted light with specific spectrum may be obtained by variations of different LED driving current combinations. The emitted light with specific spectrum ranges from ultraviolet light to red light can be obtained. Therefore, the phosphor resin layers 362 and the LED module with the three wavelength pumping chips 20A may be applied to the liquid cooled LED device 1, which can provide the waterproofing effect, the tunable emission color effect, and the full emission spectrum including visible and ultraviolet. In practical applications, the invention may also be applied to plant growth lamps or water immersion lamp for water treatment, algae growth and fishing, and is not limited to the above applications.

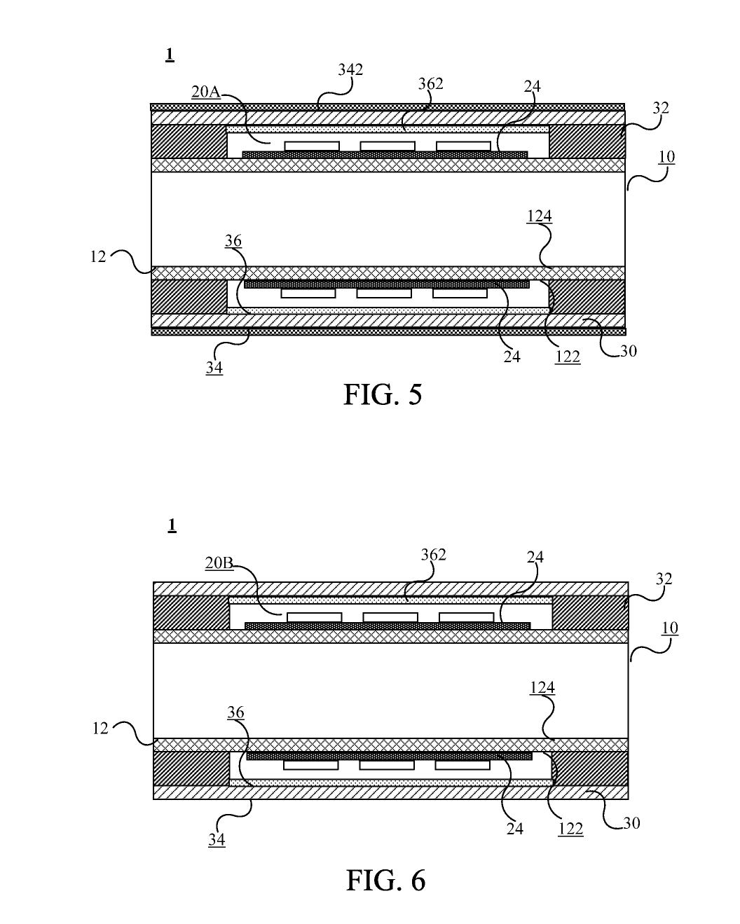

Please refer to FIG. 5, which illustrates a schematic diagram of the liquid cooled LED device according to the fourth embodiment of the invention. The present invention provides a liquid cooled LED device 1, which uses a phosphor resin layers 362 and a LED module with three wavelength pumping LED chips 20A, and also coated a photocatalyst layer 342 with single or plural stacks on the outer surface 34 of the hollow outer tube 30. The photocatalyst layer 342 can also be functioned as an optical diffuser to provide uniform emitted visible light intensity distribution. The photocatalyst layer 342 can also induce a photocatalytic reaction taking place at the outer surface 34 of the hollow outer tube 30 while being exposed to the ultraviolet light from the LED module with three wavelength pumping chips 20A, which provides the effect of degradation of organics for interior deodorization and sterilization on the outer surface 34 of the hollow outer tube 30. Therefore, in the present embodiment, the phosphor resin layers 362, the LED module with three wavelength pumping chips 20A and the photocatalyst layer 342 with single or plural stacks is applied to the liquid cooled LED device 1, which can then provide the effect of waterproofing, tunable emission color, degradation of organics for indoor deodorization and sterilization. In practical applications, the invention may also be applied to plant growth lamps, water treatment and is not limited to the above applications.

Please refer to FIG. 6, which illustrates a schematic diagram of the liquid cooled LED device according to the fifth embodiment of the invention. The present invention provides a liquid cooled LED device 1, which comprises a LED array module 20. The LED array module 20 may be a LED module comprises one or plural blue LED chip or purple LED chip or ultraviolet LED chip. The LED module with single wavelength LED 20B is set on the outer surface 122 of the inner tube for water conveyance 12. The inner surface 36 of the hollow outer tube 30 is coated with a phosphor resin layer 362 of a mixing of single or multiple color phosphors and transparent optical resin. The coating of the phosphor resin layer 362 can also be dispensed directly into the LED module with the three wavelength pumping chips 20A. In the present embodiment, the yellow phosphor resin is excited by the blue-light LED to produce the white light, but is not limited to the above application. In practical applications, the white light may also be produced by using the ultraviolet light or purple light emitted from the ultraviolet LED or purple LED respectively to excite different colors of the phosphor resin. In practical applications, the invention may also be applied to plant growth lamps or water immersion lamps, and is not limited to the above applications. In the present embodiment, the inner surface 36 of the hollow outer tube 30 without the coating of the phosphor resin layer 362 can still have the function of waterproofing, degradation of organics for deodorization, and sterilization by utilizing the ultraviolet light from the LED array module 20.

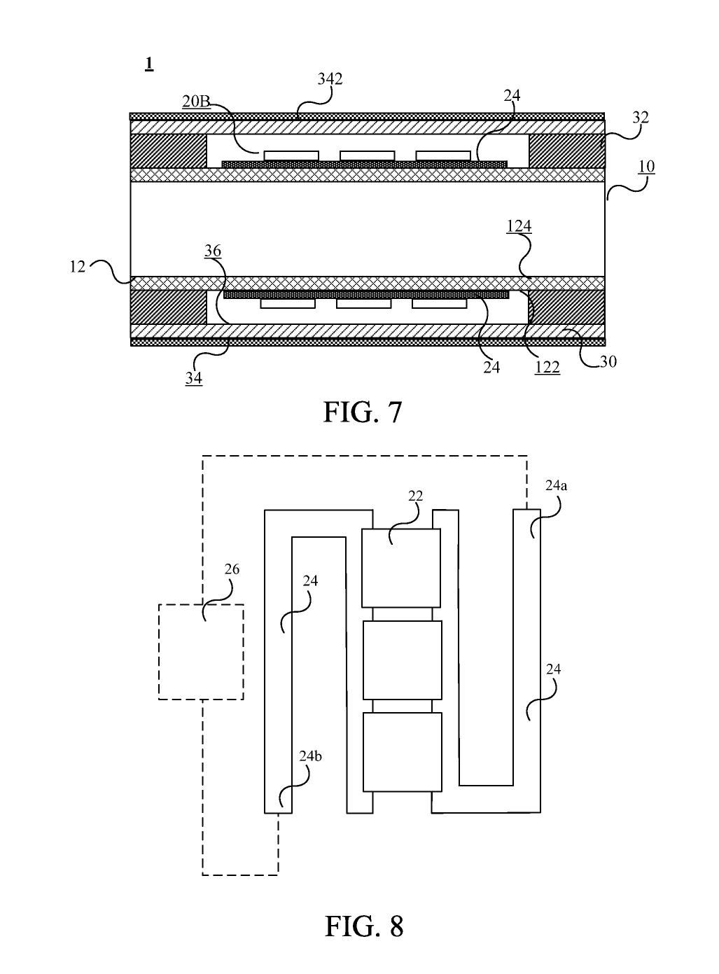

Please refer to FIG. 7, which illustrates a schematic diagram of the liquid cooled LED device according to the sixth embodiment of the invention. The present invention provides a liquid cooled LED device 1, which applies the LED module with single wavelength LED 20B and also coats a photocatalyst layer 342 with single or plural stacks on the outer surface 34 of the hollow outer tube 30 to provide the function of waterproofing, degradation of organics, for deodorization and sterilization. In practical applications, the invention may also be applied to sewage treatment lamps, and is not limited to the above applications.

Compared to the prior art, the present invention provides a liquid cooled LED device, which provides an omnidirectional or semi-omnidirectional illumination pattern by the LED array module set on the cylindrical outer surface of the inner tube for water conveyance to achieve the heat dissipation effect. Furthermore, the invention may also use the hollow outer tube to cover the outer surface of the inner tube for water conveyance to achieve the effect of waterproofing. Therefore, the invention can be applied to plant growth lamps with an omnidirectional or semi-omnidirectional illumination pattern, while also lowering and stabilizing the temperature of a greenhouse with minimal energy consumption to keep plant growth. Moreover, the invention can be immersed directly into water; the cooling effect is achieved by flowing water through the inner tube due to convection, which can be applied to fishing lamps, sewage treatment lamps, or water immersion plant lamps. Therefore, the present invention can solve the disadvantages of conventional liquid cooled LED device, such as being unable to supply an omnidirectional or semi-omnidirectional illumination pattern and being unable to implement the LED light source in water.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the meets and bounds of the appended claims.

1. A liquid cooled LED device comprising:
a cooling module, comprising a inner tube for liquid conveyance having an outer surface and an pipe, the pipe for providing a cooling liquid to flow through;
a LED array module, set on the outer surface of the inner tube for liquid conveyance; and
a hollow outer tube, for covering the outer surface of the inner tube for liquid conveyance, and two ends of the hollow outer tube sealed for preventing the cooling liquid from permeating into the LED array module set on the outer surface of the inner tube.

2. The liquid cooled LED device of claim 1, wherein the LED array module is an LED module with three wavelength pumping chips of blue wavelength, purple wavelength and ultraviolet wavelength.

3. The liquid cooled LED device of claim 1, wherein the LED array module is a LED module with a single wavelength of blue or purple or ultraviolet wavelength.

4. The liquid cooled LED device of claim 1, wherein the LED array module comprises a plurality of light emitting components and a driving circuit, each light emitting component comprises at least one LED chip and a lead frame, where the at least one LED chip is attached on the lead frame, the lead frame is attached on the outer surface of the inner tube for liquid conveyance by thermal adhesive and connected to the driving circuit.

5. The liquid cooled LED device of claim 4, wherein the plurality of light emitting components are set on the outer surface of the inner tube for liquid conveyance in an omnidirectional configuration.

6. The liquid cooled LED device of claim 4, wherein the plurality of light emitting components are set on the outer surface of the inner tube for liquid conveyance in a semi-omnidirectional configuration.

7. The liquid cooled LED device of claim 1, wherein the hollow outer tube is a hollow acrylic tube having an outer surface and an inner surface.

8. The liquid cooled LED device of claim 7, wherein the outer surface of the hollow outer tube is coated by a single layer of photocatalyst or plural stacks of photocatalyst.

9. The liquid cooled LED device of claim 7, wherein the inner surface of the hollow outer tube is coated by a phosphor resin layer with single color or multiple color phosphors.

10. The liquid cooled LED device of claim 1, wherein the cooling module further comprises a piping, a pump and a heat sink, the piping is connected to the two ends of the pipe of the inner tube for liquid conveyance, the pump is connected to the piping for pumping the cooling liquid through the inner tube for liquid conveyance and the piping, the heat sink is connected to the piping for cooling the cooling liquid, where the cooling liquid is a cooling water for generating a cooling effect by flowing through the inner tube, and the cross-sectional area of the inner tube is circular.
